(19) United States
(12) Patent Application Publication
(10) Pub. No.: US 2026/0261860 A1
(43) Pub. Date: Sep. 3, 2026

(54) DECEPTION NETWORK REDIRECTION IN TELECOMMUNICATIONS NETWORKS

(71) Applicant: BOOST SUBSCRIBERCO L.L.C., Englewood, CO (US)

(72) Inventor: Dale Drew, Arvada, CO (US)

(21) Appl. No.: 19/068,792

(22) Filed: Mar. 3, 2025

(51) Int. Cl. H04W 12/122; H04W 24/08; H04W 48/02; H04W 76/10; H04W 76/30

(52) U.S. Cl. CPC H04W 12/122; H04W 24/08; H04W 48/02; H04W 76/10; H04W 76/30

(57) ABSTRACT

Systems and methods of session management in a telecommunications network implement and/or comprise establishing a packet data session for a user equipment, the packet data session corresponding to communications between the user equipment and a data network; monitoring an interaction between the user equipment and the data network via the packet data session; and in response to a determination that the packet data session is indicative of a malicious actor: modifying the packet data session to cause the packet data session to correspond to communications between the user equipment and a deception network, and performing a remedial action based on at least one of the interaction between the user equipment and the data network and an interaction between the user equipment and the deception network.

### BACKGROUND

This disclosure relates to wireless data networks, such as 5G wireless networks. Wireless networks that transport digital data and telephone calls are becoming increasingly sophisticated. Currently, fifth generation (5G) broadband cellular networks are being deployed around the world. These 5G networks use emerging technologies to support data and voice communications with millions, if not billions, of mobile phones, computers, and other devices. 5G technologies are capable of supplying much greater bandwidths than previously available technologies.

The discussion above is merely provided for general background information and is not intended to be used as an aid in determining the scope of the claimed subject matter.

### SUMMARY

Various aspects of the present disclosure relate to systems and methods in a telecommunications or other network to provide session management and security, such as through the use of a deception network.

According to one aspect of the present disclosure, a method of managing communication sessions in a telecommunications network is provided. The method comprises establishing a packet data session for a user equipment, the packet data session corresponding to communications between the user equipment and a data network; monitoring an interaction between the user equipment and the data network via the packet data session; and in response to a determination that the packet data session is indicative of a malicious actor: modifying the packet data session to cause the packet data session to correspond to communications between the user equipment and a deception network, and performing a remedial action based on at least one of the interaction between the user equipment and the data network and an interaction between the user equipment and the deception network.

According to another aspect of the present disclosure, a network node is provided. The network node comprises a memory; and at least one electronic processor operatively connected to the memory, and configured to cause the first network node to perform operations comprising: establishing a packet data session for a user equipment, the packet data session corresponding to communications between the user equipment and a data network, monitoring an interaction between the user equipment and the data network via the packet data session, and in response to a determination that the packet data session is indicative of a malicious actor: modifying the packet data session to cause the packet data session to correspond to communications between the user equipment and a deception network, and performing a remedial action based on at least one of the interaction between the user equipment and the data network and an interaction between the user equipment and the deception network.

According to another aspect of the present disclosure, a non-transitory computer-readable medium is provided. The non-transitory computer-readable medium stores instructions that, when executed by at least one processor of a network node in a telecommunications network, cause the telecommunications network to perform operations comprising establishing a packet data session for a user equipment, the packet data session corresponding to communications between the user equipment and a data network, monitoring an interaction between the user equipment and the data network via the packet data session, and in response to a determination that the packet data session is indicative of a malicious actor: modifying the packet data session to cause the packet data session to correspond to communications between the user equipment and a deception network, and performing a remedial action based on at least one of the interaction between the user equipment and the data network and an interaction between the user equipment and the deception network.

### BRIEF DESCRIPTION OF THE DRAWINGS

The following drawings are provided to help illustrate various features of examples of the disclosure and are not intended to limit the scope of the disclosure or exclude alternative implementations.

FIG. 1 illustrates an example of a telecommunications network in accordance with various aspects of the present disclosure.

FIG. 2 illustrates an example of a service-based architecture for a telecommunications network in accordance with various aspects of the present disclosure.

FIG. 3 illustrates an example of a message flow in accordance with various aspects of the present disclosure.

FIG. 4 illustrates an example of a deception network redirection method in accordance with various aspects of the present disclosure.

### DETAILED DESCRIPTION

The disclosed technology is not limited in its application to the details of construction and the arrangement of components set forth in the following description or illustrated in the following drawings. Other examples of the disclosed technology are possible and examples described and/or illustrated here are capable of being practiced or of being carried out in various ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in at least one example, the electronic based aspects of the disclosed technology can be implemented in software (for example, stored on non-transitory computer-readable medium) executable by one or more electronic processors. Although certain drawings illustrate hardware and software located within particular devices, these depictions are for illustrative purposes only. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computing device or can be distributed among different computing devices connected by one or more networks or other suitable communication links.

The present disclosure is, in examples, directed to wireless communications networks, also referred to herein as telecommunications networks. The systems and methods set forth herein may be implemented on a telecommunications network in compliance with any telecommunication standard or group of standards; for example, fourth-generation (4G) network standards such as Long Term Evolution (LTE) and/or fifth-generation (5G) network standards such as New Radio (NR). In an example implementation, the wireless communications networks described herein may represent a portion of a wireless network built around 5G standards promulgated by standards setting organizations under the umbrella of the Third Generation Partnership Project (“3GPP”). Accordingly, in some configurations, the wireless communication network may be a 5G network, such as, e.g., a 5G cellular network. Such 5G networks, including the wireless communication networks described herein, may comply with industry standards, such as, e.g., the Open Radio Access Network (Open RAN or O-RAN) standard that describes interactions between the network and user equipment (e.g., mobile phones and the like).

The O-RAN model follows a virtualized model for a cloud-native 5G wireless architecture in which 5G base stations, referred to as next-generation Node Bs (gNBs), are implemented using separate centralized units (CUs), distributed units (DUs), and radio units (RUs). In some configurations, O-RAN CUs and DUs may be implemented using software modules executed by distributed (e.g., cloud) computing hardware. Virtualization allows for various other components of the cellular network, such as cellular network core functions, to be implemented as code that is executed using general-purpose computing resources. Such general-purpose computing resources can be part of a public cloud-computing platform that provides virtual private clouds (VPCs) for multiple clients. On a hybrid cloud cellular network, RAN components of the cellular network are in communication with components of the cellular network executed on a public cloud computing platform, such as Amazon Web Services (AWS).

For voice communications, including Voice over LTE (VoLTE) using 5G networks, Voice over Wi-Fi (VoWi-Fi) using wireless internet networks, and Voice over NR (VoNR) using 5G networks, an Internet Protocol (IP) Multimedia Subsystem (IMS) framework may be provided. Collectively, these may referred to as Voice over IMS (VoIMS). By using VoIMS technologies, communications are routed via an IMS Core such that connections can be established and maintained between users of a first network and users of a second network, even if the second network is different from the first network, and even if the second network is based on a different architecture than the first network (e.g., between NR users and LTE users).

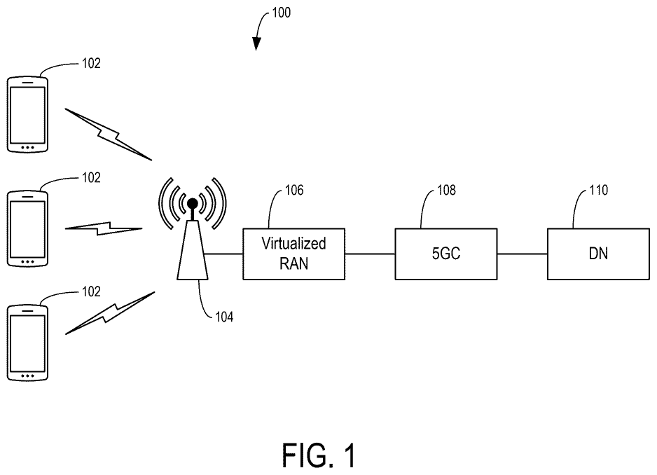

FIG. 1 illustrates an example of a telecommunications network 100 in accordance with various aspects of the present disclosure. In the telecommunications network 100 of FIG. 1, a plurality of UEs 102 are connected to a wireless access point 104, which in turn is connected to a set of virtualized RAN components 106. The virtualized RAN components 106 provide a connection to a 5G core network (5GC) 108, which in turn provides a connection to a data network 110. The wireless access point 104 and the virtualized RAN components 106 may collectively be referred to as a next-generation RAN (NG-RAN).

In some configurations, the telecommunications network 100 may be a standalone (SA) network (e.g., a 5G SA network) that utilizes 5G cells for both signaling and information transfer via a 5G packet core architecture. However, the present disclosure may be implemented with any type of telecommunication network capable of being virtualized.

As used herein, the term “UE” may be one of various types of end-user devices, such as cellular phones, smartphones, cellular modems, cellular-enabled computerized devices, sensor devices, robotic equipment, vehicles, IoT devices, gaming devices, access points (APs), or any computerized device capable of communicating via a cellular network. More generally, a UE 102 can represent any type of device that has an incorporated 5G interface, such as a 5G modem. Examples can include sensor devices, Internet of Things (IoT) devices, manufacturing robots, unmanned aerial (or land-based) vehicles, network-connected vehicles, etc. Depending on the location of individual UEs, a UE 102 may use RF to communicate with various base stations of a telecommunications network. While FIG. 1 illustrates three UEs 102 connected to the wireless access point 104, in practical implementations any number of UEs 102 may be connected to the wireless access point 104 at any given time.

The wireless access point 104 represents the physical infrastructure (e.g., a 5G tower) to which the UEs 102 connect. The wireless access point 104 may be any structure to which one or more antennas are mounted. The wireless access point 104 may be a dedicated cellular tower, a building, a water tower, or any other man-made or natural structure to which one or more antennas can reasonably be mounted to provide cellular coverage to a geographic area. The wireless access point 104 may include an RU configured to convert radio signals sent to and received from the antenna(s) into a digital signal. The wireless access point 104 is connected to the virtualized RAN components 106 via a fronthaul link over which the digital signals may be communicated. The virtualized RAN components 106 may include a DU connected to a CU via a midhaul link. The CU may be connected to the 5GC 108 via a backhaul link. While FIG. 1 illustrates a single wireless access point 104 and a single set of virtualized RAN components 106, in practical implementations the telecommunications network 100 may include any number of wireless access points 104 and/or any number of virtualized RAN components 106.

In one example, the telecommunications network 100 may be configured according to a region-based network topology. For example, the telecommunications network 100 may be implemented using a cloud computing platform that is logically and physically divided up into various different cloud computing regions (e.g., AWS regions). The cloud computing regions may be based on the geographical location of the gNBs; for example, the telecommunications network 100 for a given nation may be divided into a number of geographical regions. Each of the cloud computing regions can be isolated from other cloud computing regions to help provide fault tolerance, fail-over, load-balancing, and/or stability and each of the cloud computing regions can be composed of multiple availability zones or markets, each of which can be a separate data center located in general proximity to each other (e.g., within 100 miles). For example, one cloud computing region may have its datacenters and hardware located in the northeast of the United States while another cloud computing region may have its data centers and hardware located in California.

Each of the availability zones may be a discrete data center of a group of data centers that allows for redundancy, thereby to provide fail-over protection from other availability zones within the same cloud computing region. For example, if a particular data center of an availability zone experiences an outage, another data center of the availability zone or separate availability zone within the same cloud computing region can continue functioning and providing service. An availability zone may be divided into multiple local zones or areas-of-interest (AOIs). For instance, a client, such as a provider of the telecommunications network 100, can select from more options of the computing resources that can be reserved at an availability zone compared to a local zone. However, a local zone may provide computing resources nearby geographic locations where an availability zone is not available. Each local zone may be divided into multiple gNBs, each of which can serve one or more sites. A site may have one DU and a number of RUs (e.g., six RUs) assigned to it.

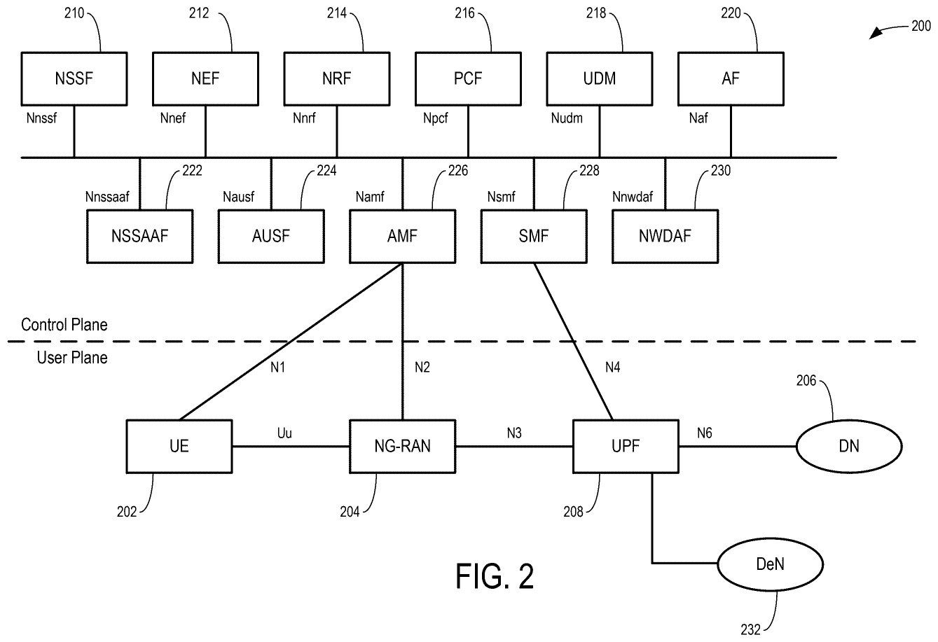

The 5GC 108 provides a plurality of 5G core functions. In the topology of a 5G NR cellular network, 5G core functions of 5GC 108 can logically reside as part of a national data center (NDC). An NDC can be understood as having its functionality existing in a cloud computing region across multiple availability zones. This arrangement allows for load-balancing, redundancy, and fail-over. In local zones, multiple regional data centers can be logically present. Each of regional data centers may execute 5G core functions for a different geographic region or group of RAN components. An example of 5G core components that can be executed within an RDC are described in more detail with regard to FIG. 2. The data network 110 may be the Internet, an enterprise data network, combinations thereof, and the like.

FIG. 2 illustrates an example service-based architecture (SBA) 200 for a telecommunications network (e.g., the telecommunications network 100 of FIG. 1) in accordance with various aspects of the present disclosure. The SBA 200 includes an infrastructure domain, which is divided between a control plane (CP) and a user plane (UP). The CP comprises a plurality of CP network functions (NFs). The UP comprises a UE 202 (e.g., one of the UEs 102 of FIG. 1) connected to an NG-RAN 204, and UP NFs. Using the SBA 200, the UE 202 accesses a data network 206 (e.g., the data network 110 of FIG. 1). For ease of illustration, FIG. 2 only shows a single UE 202 being connected to the NG-RAN 204; however, in practical implementations any number of UEs 202 may be present, limited only by the capacity of the network.

The UP NFs include a User Plane Function (UPF) 208. The UPF 208 is a network function that routes and forwards user plane data packets between the base station (cell site; for example, the NG-RAN 204) and the external data network 206 (e.g., the Internet). The UPF 208 is similar to the service and packet gateway functions in a 4G network, but it is cloud-native and can be deployed anywhere to meet service requirements. It can also manage, prioritize, and duplicate data packets as they traverse the network, thus offering redundancy and quality-of-service (QoS) assurance.

The CP NFs include a Network Slice Selection Function (NSSF) 210, a Network Exposure Function (NEF) 212, a Network Repository Function (NRF) 214, a Policy Control Function (PCF) 216, a Unified Data Management (UDM) 218, an Application Function (AF) 220, a Network Slice-specific and SNPN Authentication and Authorization Function (NSSAAF) 222, an Authentication Server Function (AUSF) 224, an Access and Mobility Management Function (AMF) 226, a Session Management Function (SMF) 228, and a Network Data Analytics Function (NWDAF) 230.

The NSSF 210 is a CP function that provides network slices to the AMF 226. A network slice is an independent, end-to-end logical network that runs on shared physical network infrastructure. It involves the allocation of network resources across all network infrastructure to meet specific service requirements, from the network core to the radio access network (RAN). Specific requirements may include QoS assurance, security policies, data isolation, dynamic policy management, etc.

The NEF 212 is a CP function that provides information regarding the network functions that are available to use (by the enterprise customer). It is similar to the 4G Service Capabilities Exposure Function (SCEF), but it is cloud-native and exposes event information, network monitoring, network control, provisioning capabilities, and policy/charging capabilities externally. This allows the enterprise customer to monitor and affect QoS and charging for devices.

The NRF 214 is a CP function that allows 5G network functions to be registered, discovered, and subsequently made available to customers. This is a unique capability in the standalone 5G network that allows customers to subscribe to the necessary microservices or to have dedicated network functions for their services.

The PCF 216 is a CP function that provides policies for mobility and session management. It is similar to the Policy and Charging Rules Function (PCRF) in a 4G network, but it is cloud-native and offers additional capabilities in the 5G network, including event-based policy triggers, resource reservation requests, and access network discovery and selection. The PCF directly influences QoS and subscriber spending limits, and as a result plays a role in the enhanced policy management and control capabilities of the 5G network.

The UDM 218 is a CP function that manages and stores subscriber and device information, default QoS and prioritization, authorized data channels, maximum bit rates, service continuity provisions, and the like. The UDM 218 is similar to the Home Subscriber Server (HSS) function in a 5G network, but it is cloud-native and designed for 5G services.

The AF 220 is a CP function that interacts with the 3GPP Core Network in order to provide services, for example to support one or more of application function influence on traffic routing, application function influence on service function chaining, accessing the NEF 212, interacting with the PCF 216, time synchronization service, IP multimedia subsystem (IMS) interactions with the 5GC, or packet data unit (PDU) set handling.

The NSSAAF 222 is a CP function that supports authentication and authorization of slicing with an AAA server (Authentication, Authorization, and Accounting). It is a unique capability of the standalone 5G network that allows customers to access a predefined network slice or a newly requested network slice in real-time and using their own existing authentication infrastructure.

The AUSF 224 is a CP function that supports authentication for 3GPP access and untrusted non-3GPP access, and authentication of a UE for a disaster roaming service. It can act as an authentication server.

The AMF 226 is a CP function that manages registration, authorization, connection, reachability, and mobility. It is similar to the Mobility Management Entity (MME) function in a 4G network, but it is cloud-native and supports many additional capabilities unique to 5G. For example, it also supports dynamic updating of network interfaces and cellular sites, greater privacy via the use of a 5G temporary device identity, enhanced security across the user and control planes, and stores network slice information. It can also select an appropriate PCF for a device or use case.

The SMF 228 is a CP function that oversees packet data session management, IP address allocation, data tunneling from a cell site base station to the user plane function, and downlink notification management. It performs the tasks of the serving and packet gateways (S-GW & P-GW) in a 4G network, but also allows for control plane and user plane separation in 5G.

The NWDAF 230 is a CP function that collects data from pertinent network infrastructure relevant to a customer's services, including user equipment (device), network functions, network operations and administration, cloud, and edge that can be used for data analytics and insights. It is a unique standalone 5G network function that exposes full visibility to network performance and operations as they relate to a customer's key performance indicators (KPIs).

The SBA 200 further includes a plurality of service-based interfaces to provide access to or communication with the various NFs. As illustrated, these include an Nnssf interface for the NSSF 210, an Nnef interface for the NEF 212, an Nnrf interface for the NRF 214, an Npcf for the PCF 216, an Nudm interface for the UDM 218, an Naf interface for the AF 220, an Nnssaaf interface for the NSSAAF 222, an Nausf interface for the AUSF 224, an Namf interface for the AMF 226, an Nsmf interface for the SMF 228, and an Nnwdaf interface for the NWDAF 230. FIG. 1 also illustrates several reference points (i.e., interfaces between two NFs or entities), including an N1 interface between the UE 202 and the AMF 226, a Uu interface between the UE 202 and the NG-RAN 204, an N2 interface between the NG-RAN 204 and the AMF 226, an N3 interface between the NG-RAN 204 and the UPF 208, an N4 interface between the UPF 208 and the SMF 228, and an N6 interface between the UPF 208 and the data network 206. Any of the above-described interfaces may be an SBI interface (e.g., an http2 based interface).

The above-listed NFs and interfaces are intended to be illustrative and not exhaustive. In practical implementations, the SBA 200 may include additional NFs or other network entities, such as an Unstructured Data Storage Function (UDSF), a Network Slice Admission Control Function (NSCAF), a Unified Data Repository (UDR), a UE radio Capability Management Function (UCMF), a 5G-Equipment Identity Register (5G-EIR), a Charging Function (CHF), a Time Sensitive Networking AF (TSN AF), a Time Sensitive Communication and Time Synchronization Function (TSCTSF), a Data Collection Coordination Function (DCCF), an Analytics Data Repository Function (ADRF), a Messaging Framework Adaptor Function (MFAF), a Non-Seamless WLAN Offload Function (NSWOF), an Edge Application Server Discovery Function (EASDF), a Service Communication Proxy (SCP), a Security Edge Protection Proxy (SEPP), a Non-3GPP InterWorking Function (N3IWF), a Trusted Non-3GPP Gateway Function (TNGF), a Wireline Access Gateway Function (W-AGF), or a Trusted WLAN Interworking Function (TWIF).

Any of the NFs illustrated in FIG. 2 and/or described above may be implemented as a software unit residing on a server (i.e., in the cloud). Each NF can include multiple pods. A “pod” refers to a software sub-component of the NF. Kubernetes, Docker, or some other container orchestration platform can be used to create and destroy the logical CU or 5G core units and subunits as needed for the data network 110 to function properly. The pods may be deployed on one or more virtual machines configured by a network operator. Kubernetes allows for container deployment, scaling, and management. As an example, if cellular traffic increases substantially in a region, an additional logical CU or components of a CU may be deployed in a data center near where the traffic is occurring without any new hardware being deployed. Instead, processing and storage capabilities of the data center would be devoted to the needed functions. When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers. Thus, the SBA 200 may be implemented on or using one or more computing devices, each of which includes a processor and a memory.

As used herein, a “processor” may include one or more individual electronic processors, each of which may include one or more processing cores, and/or one or more programmable hardware elements. The processor may be or include any type of electronic processing device, including but not limited to central processing units (CPUs), graphics processing units (GPUs), application-specific integrated circuits (ASICs), field-programmable gate arrays (FPGAs), microcontrollers, digital signal processors (DSPs), or other devices capable of executing software instructions. When a device is referred to as “including a processor,” one or all of the individual electronic processors may be external to the device (e.g., to implement cloud or distributed computing). In implementations where a device has multiple processors and/or multiple processing cores, individual operations described herein may be performed by any one or more of the microprocessors or processing cores, in series or parallel, in any combination. In some implementations, one or more of the processing units or processing cores may be remote (e.g., cloud-based).

As used herein, a “memory” may be any storage medium, including a non-volatile medium, e.g., a magnetic media or hard disk, optical storage, or flash memory; a volatile medium, such as system memory, e.g., random access memory (RAM) such as dynamic RAM (DRAM), synchronous dynamic RAM (SDRAM), static RAM (SRAM), extended data out (EDO) DRAM, extreme data rate dynamic (XDR) RAM, double data rate (DDR) SDRAM, etc.; on-chip memory; and/or an installation medium where appropriate, such as software media, e.g., a CD-ROM, or floppy disks, on which programs may be stored and/or data communications may be buffered. The term “memory” may also include other types of memory or combinations thereof. For the avoidance of doubt, cloud storage is contemplated in the definition of memory. A memory is an example of a non-transitory computer-readable medium which stores instructions that are executable by a processor (or processors), the execution of which causes the executing device (e.g., a computer) to perform certain operations, such as those operations described herein.

In the SBA 200 shown in FIG. 2, the NG-RAN 204 may include some or all of the virtualized RAN components 106 illustrated in FIG. 1. Thus, the NG-RAN 204 may include at least one CU, at least one DU configured to operate under the control of one or more of the at least one CU, and at least one RU configured to operate under the control of one or more of the at least one DU. For example, each CU in the NG-RAN 204 may control a plurality of DUs, each of which in turn may control a plurality of RUs. Each RU may be operatively connected to a power amplifier and transmission elements (e.g., antennae) configured to cooperate to transmit signals to connected UEs 202 according to a transmission schedule.

In examples, the SBA 200 may be applicable to a particular cloud computing region. For example, as noted above, one instance of the SBA 200 may exist within a first geographical region (e.g., the northeastern United States) while another instance of the SBA 200 may exist within a second geographical region (e.g., the western United States). In this implementation, the above described NFs may be embodied in the form of computing nodes in data centers located within the corresponding geographical region. Thus, the first instance of the SBA 200 may be implemented by computing nodes in one or more data centers physically located in the northeastern United States, the second instance of the SBA 200 may be implemented by computing nodes in one or more data centers physically located in the western United States, and so on. Within each instance of the SBA 200, the computing nodes may be configured to implement at least instance of each of the above-described NFs.

The SBA 200 may be prone to security risks that are not addressed by comparative network implementations. For example, some organizations may elect to build their own local 5G networks, thereby providing additional opportunities for network vulnerabilities if the network and/or network equipment is improperly deployed, configured, or managed. Moreover, the supply chain itself may introduce opportunities for the malicious or unintentional introduction of vulnerabilities, such as malware, counterfeit components, or poor designs or processes. Thus, for comparative examples of network management, the network may expose communications infrastructure or user information to malicious actors. Herein, the term “malicious actors” encompasses not only those actors with malicious intent in accessing the network (e.g., hackers), but also actors without malicious intent whose access to the network otherwise introduces security concerns (e.g., unpatched devices, improper device configurations, etc.).

In comparative examples, an operator of the network must continuously monitor for malicious actors and, only once they are detected, is able to perform a remedial action such as quarantining them and/or booting them from the network. However, this comparative approach suffers from several disadvantages that ultimately result in significantly reduced network security and user experience. For example, the comparative remedial action is immediately noticeable to the malicious actor, who may then attempt to modify their strategy in order to circumvent the security monitoring. The comparative approach is further limited in that the network operator is only able to obtain very limited information regarding the malicious actor's goals and/or techniques. That is, as soon as the malicious actor is booted from the network or quarantined, the network operator loses the ability to monitor the actions performed by the malicious actor. If, instead, the network operator were to retain the malicious actor in the network (e.g., in order to determine that the malicious actor is targeting a particular network node, seeking subscriber information, using particular techniques, etc.), the network operator necessarily places sensitive computing assets and/or subscriber information at risk.

The present disclosure address these and other limitations in the comparative approaches. In some examples, the present disclosure includes systems, methods, and computer-readable media that implement a monitoring network that provides for the ability for a network operator to perform remedial actions without notifying the malicious actor. As illustrated in FIG. 2, the UPF 208 may further be configured to provide a connection to a deception network 232. The deception network 232 may be used to monitor malicious actor activity, to perform policy enforcement functions, to address security loopholes, and the like. From the point of view of the UE 202, there is no difference between the deception network 232 and the data network 206. Thus, the UE 202 has no way of determining that it is connected to the deception network 232 instead of the data network 206.

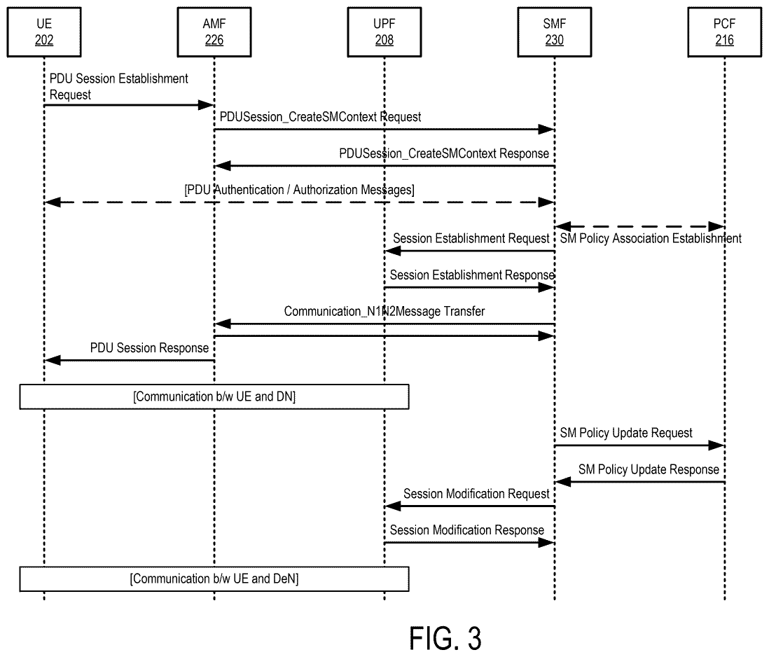

These and other NFs operate together to perform and/or manage various procedures within the network, including connection, registration, mobility management, and network redirection procedures. For example, in order to receive services from the network, a UE must first register with the network (e.g., when initially joining the network, when moving to a new tracking area within the network, and so on). When the UE seeks to register with the network, a series of operations are performed, including the transmission of messages between the various network entities (e.g., between various NFs) of the SBA 200. These operations include an NR attach procedure and PDU session establishment procedures. FIG. 3 illustrates an example communication flow in accordance with various aspects of the present disclosure. In particular, FIG. 3 shows a subset of messages among the UE 202, the UPF 208, the PCF 216, the AMF 226, and the SMF 228, although it should be noted that additional NFs (e.g., the UDM 218, the AUSF 224, etc.) may be implicated in registration and/or redirection operations not illustrated in FIG. 3, such as registration and/or redirection operations that occur prior to or subsequent to those illustrated in FIG. 3. The illustration of FIG. 3 begins with the PDU session establishment procedure, which may occur during the registration procedure after the UE 202 sends a registration request to the AMF 226 and authentication and/or security operations are performed.

The PDU session establishment procedure begins with the UE 202 sending a PDU Session Establishment Request to the AMF 226. The AMF 226 in turn sends a PDUSession_CreateSMContext Request (or, if another PDU session already exists for the PU Session ID, a PDUSession_UpdateSMContext Request) to the SMF 228 via the Nsmf interface. At this point, additional messages may be exchanged among the various NFs, including messages for PDU session authentication/authorization and for policy association establishment or modification. The SMF 228 may then perform an SM Policy Association Establishment procedure to establish an SM Policy Association with the PCF 216 and obtain the default Policy Charging and Control (PCC) Rules for the PDU Session.

The SMF 228 may then perform an N4 Session Establishment procedure to create the initial N4 session context for the PDU session at the UPF 208. In this procedure, the SMF 228 establishes a Session ID and transmits it to the UPF 208, along with any packet detection, enforcement, and reporting rules to be installed on the UPF 208 for this PDU session. The UPF 208 acknowledges by sending Session Establishment Response message to the SMF 228. At this point, the SMF 228 may store the relation between the Session ID and the PDU session for a given UE 202. The SMF 228 resolves various network parameters (e.g., proxy call serving function IP addresses for voice services, etc.) and transmits various information in the PDU Session Response portion of a Communication_N1N2Message Transfer via the AMF 226.

With the PDU session established between the UE 202 and the data network 206, communication may occur therebetween for some time. The UPF 208 may deliver any uplink packets from the UE 202 to the data network 206, and may deliver any downlink packages from the data network 206 to the UE 202. During this communication session, a security apparatus may monitor the communication session to determine whether any unusual, suspicious, or unauthorized activity occurs. In some examples, the security apparatus may be the SMF 228 or a component thereof. However, in other examples the security apparatus may be implemented on another NF. In any example, the monitoring may be included as a portion of Security Orchestration, Automation, and Response (SOAR) monitoring that is already being performed in the network. Malicious activity may be detected when there is potential unauthorized traffic or other security conditions such as the UE 202 not being properly configured or patched. Different types of activity may be handled by changing the sensing regime.

In response to detection of a malicious actor, the SMF 228 may initiate a SM Policy Update procedure. In this procedure, the SMF 228 orchestrates the PCF 216 using an SM Policy Update Request message, and receives an SM Policy Update Response from the PCF 216. The SM Policy Update Response may include information identifying a change in DNN from the data network 206 to the deception network 232. The SMF 228 performs an N4 Session Modification procedure to update the existing PDU session at the UPF 208. The SMF 228 may generate an updated Session ID and/or provide a DNN corresponding to the deception network 232 to the UPF 208. In examples, the Session Modification Request may include AN Tunnel Info for the UPF 208 as well as corresponding forwarding rules. The UPF 208 updates parameters of the session context based on the information newly provided by the SMF 228. The UPF 208 may respond with a Session Modification Response message to transmit any requisite response to the received control information. Information relating to the session modification is not passed to the UE 202, and thus the UE 202 does not know that it has been rerouted to the deception network 232. Communication now occurs between the UE 202 and the deception network 232, in which the UPF 208 may deliver any uplink packets from the UE 202 to the deception network 232 and may deliver any downlink packages from the data network 206 to the UE 202.

During this communication session, an ingressip and egressip filter may be applied to force the UE 202 into a specific policy function within the deception network 232. In one example, the UE 202 may be directed to a “honeypot” used to capture the malicious actor's activity. Information may thus be acquired regarding tactics that the malicious actor is using in an attempt to compromise systems, maliciously obtain user information, and the like. This information may be used to enhance network security policies, for example by closing loopholes, understanding zero-day exploits, etc. Additionally or alternatively, the UE 202 can be directed to a policy server on the deception network 232 that can be used to assist the user in getting the UE 202 in compliance with required security policies (e.g., by patching the UE 202). Once activity on the deception network is completed (e.g., the network operator has obtained sufficient information on techniques used by a malicious actor, a non-compliant device has been patched, etc.), the UE 202 can be disconnected from the network or directed back to the initial DNN (e.g., through the exchange of additional messages among the SMF 228, the PCF 216, and the UPF 208.

In some examples, the deception network 232 may be an existing network (e.g., a persistent “sandbox”). In other examples, one or more NFs may be used to dynamically create the environment for the deception network 232, populate the infrastructure, and place it in the communication path of the malicious actor.

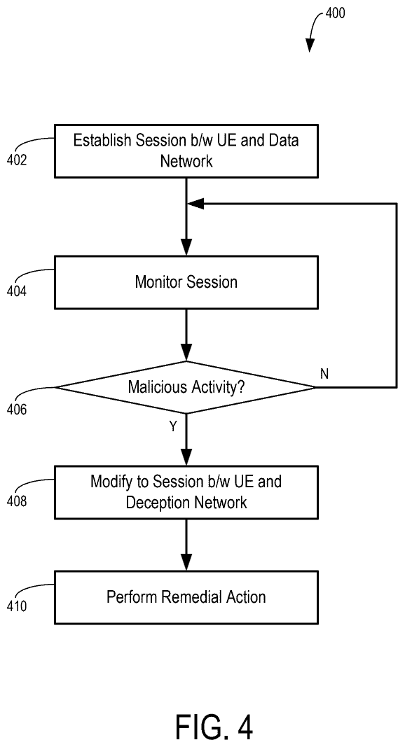

FIG. 4 illustrates an example method 400 of network session management, for example to perform deception network redirection as described above. For purposes of illustration, the method 400 will be described as being performed by or under the control of the SMF 228. However, as noted above, in some implementations the operations of method 400 may be performed by a different NF and/or by multiple NFs operating in coordination with one another. In general, the method 400 may be performed by or under the control of any network node having a memory and at least one electronic processor operatively connected thereto, and/or by executing instructions stored on a non-transitory computer-readable medium using at least one electronic processor of a network node in the telecommunications network. The method 400 is one example of a method to implement the communication flows illustrated with regard to FIG. 3 and described above.

The operation 400 includes an operation 402 of establishing a packet data session (e.g., a PDU session) for a user equipment (e.g., the UE 202), the packet data session corresponding to communications between the user equipment and a data network (e.g., the data network 206). Operation 402 may include communication flows corresponding to the PDU Session Establishment Requests and associated session establishment and context creation as described above with regard to FIG. 3. In one example, operation 402 may include providing to a UPF (e.g., the UPF 208) a DNN corresponding to the data network.

Operation 404 may then be performed, including monitoring an interaction between the UE and the data network via the packet data session. The monitoring may be performed to determine whether malicious activity is taking place (e.g., whether the UE is attempting to perform unauthorized access of network components or files, whether the UE is in need of patching or updates, etc.).

If, at operation 406, it is determined that malicious activity is not taking place, the method 400 may return to operation 404 and continue monitoring the session. Operation 404 may be performed as many times as desired during the existence of the packet data session (e.g., until the packet data session is terminated). The determination of operation 406 may be performed at predetermined intervals, which may be set by a network operator. If, at operation 406, it is determined that malicious activity is taking place, the method 400 may proceed to operation 408 and modify the packet data session to cause the packet data session to now correspond to communication between the user equipment and a deception network (e.g., the deception network 232).

Operation 408 may include communication flows corresponding to the SM Policy Update procedure described above with regard to FIG. 3. In one example, operation 408 may include providing to the UPF a DNN corresponding to the deception network. Operation 408 may be performed without informing the UE or in any way permitting the UE to realize that the packet data session has been changed. Operation 408 may be continuously or continually (e.g., at predetermined intervals) be performed.

At operation 410, one or more remedial actions may be performed. The remedial action(s) to be performed may depend on at least one of the interaction between the user equipment and the data network (e.g., information acquired before the UE was redirected to the deception network, such as a determination whether the malicious actor is attempting to compromise the network and/or whether the UE is in need of updating or patching) or the interaction between the user equipment and the deception network (e.g., information acquired after the UE was redirected to the deception network, such as observed techniques the UE is attempting and/or the completion of an update or patch procedure).

In one example, the remedial action includes further monitoring of the UE, such as monitoring the interaction between the UE and the deception network. In this example, after monitoring the interaction between the UE and the deception network (e.g., once sufficient information regarding the behavior, goals, or tactics of the UE has been collected), the remedial action may further include disconnecting and/or banning the user equipment from the telecommunications network. In another example, the remedial action includes directing the UE to a policy server or other network node to initiate an update to the UE. In this example, after the update is completed, the remedial action may include returning the UE to communication with the data network. For example, the packet data session may be modified to revert it back to communications between the UE and the data network. As above, this may be performed without informing the UE or in any way permitting the UE to realize that the packet data session has again been changed.

To perform the systems and methods set forth herein, a computing device may be provided that includes at least one processor and a non-transitory computer-readable medium storing instructions that may be executed by the at least one processor to perform various operations, such as the operations of the method 400. In an example, the computing device is a network node (e.g., the SMF 228). In another example, the computing device controls the SMF 228 server to implement the method 400. Thus, the computing device may be implemented as part of a network infrastructure disposed between the data network and the user equipment or may be implemented as a device that controls the network infrastructure and/or its components.

Other examples and uses of the disclosed technology will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

What is claimed is:

1. A method of managing communication sessions in a telecommunications network, the method comprising:
establishing a packet data session for a user equipment, the packet data session corresponding to communications between the user equipment and a data network;
monitoring an interaction between the user equipment and the data network via the packet data session; and
in response to a determination that the packet data session is indicative of a malicious actor:
modifying the packet data session to cause the packet data session to correspond to communications between the user equipment and a deception network, and
performing a remedial action based on at least one of the interaction between the user equipment and the data network and an interaction between the user equipment and the deception network.

2. The method of claim 1, wherein:
the operation of establishing the packet data session includes providing, to a User Plane Function (UPF) of the telecommunications network, a Data Network Name (DNN) corresponding to the data network; and
the operation of modifying the packet data session includes providing, to the UPF, a DNN corresponding to the deception network.

3. The method of claim 1, wherein the operation of modifying the packet data session is performed without informing the user equipment.

4. The method of claim 1, wherein the remedial action includes monitoring an interaction between the user equipment and the deception network via the packet data session.

5. The method of claim 4, wherein the remedial action includes, after monitoring the interaction between the user equipment and the deception network, at least one of disconnecting or banning the user equipment from the telecommunications network.

6. The method of claim 1, wherein the remedial action includes directing the user equipment to a policy server to initiate an update to the user equipment.

7. The method of claim 6, wherein the remedial action includes, after completing the update to the user equipment, modifying the packet data session to revert the packet data session to correspond to communications between the user equipment and the data network.

8. A first network node in a telecommunications network, the first network node comprising:
a memory; and
at least one electronic processor operatively connected to the memory, and configured to cause the first network node to perform operations comprising:
establishing a packet data session for a user equipment, the packet data session corresponding to communications between the user equipment and a data network,
monitoring an interaction between the user equipment and the data network via the packet data session, and
in response to a determination that the packet data session is indicative of a malicious actor:
modifying the packet data session to cause the packet data session to correspond to communications between the user equipment and a deception network, and
performing a remedial action based on at least one of the interaction between the user equipment and the data network and an interaction between the user equipment and the deception network.

9. The first network node of claim 8, wherein the first network node corresponds to a Session Management Function (SMF) of the telecommunications network.

10. The first network node of claim 8, wherein the operation of establishing the packet data session includes communicating with a second network node of the telecommunications network to establish a session management policy, and communicating with a third network node of the telecommunications network to transmit a data network name (DNN) corresponding to the data network.

11. The first network node of claim 10, wherein the second network node corresponds a Policy Control Function (PCF) of the telecommunications network and the third network node corresponds to a User Plane Function (UPF) of the telecommunications network.

12. The first network node of claim 10, wherein the operation of modifying the packet data session includes communicating with the second network node to modify the session management policy, and communicating with the third network node transmit a DNN corresponding to the deception network.

13. The first network node of claim 8, wherein the operation of modifying the packet data session is performed without informing the user equipment.

14. The first network node of claim 8, wherein the remedial action includes monitoring an interaction between the user equipment and the deception network via the packet data session.

15. The first network node of claim 14, wherein the remedial action includes, after monitoring the interaction between the user equipment and the deception network, at least one of disconnecting or banning the user equipment from the telecommunications network.

16. The first network node of claim 8, wherein the remedial action includes directing the user equipment to a policy server to initiate an update to the user equipment.

17. The first network node of claim 16, wherein the remedial action includes, after completing the update to the user equipment, modifying the packet data session to revert the packet data session to correspond to communications between the user equipment and the data network.

18. A non-transitory computer-readable medium storing instructions that, when executed by at least one processor of a network node in a telecommunications network, cause the telecommunications network to perform operations comprising:
establishing a packet data session for a user equipment, the packet data session corresponding to communications between the user equipment and a data network;
monitoring an interaction between the user equipment and the data network via the packet data session; and
in response to a determination that the packet data session is indicative of a malicious actor:
modifying the packet data session to cause the packet data session to correspond to communications between the user equipment and a deception network, and
performing a remedial action based on at least one of the interaction between the user equipment and the data network and an interaction between the user equipment and the deception network.

19. The non-transitory computer-readable medium of claim 18, wherein:
the operation of establishing the packet data session includes providing, to a User Plane Function (UPF) of the telecommunications network, a Data Network Name (DNN) corresponding to the data network; and
the operation of modifying the packet data session includes providing, to the UPF, a DNN corresponding to the deception network.

20. The non-transitory computer-readable medium of claim 18, wherein the operation of modifying the packet data session is performed without informing the user equipment.
